(19) United States
(12) Patent Application Publication
(10) Pub. No.: US 2008/0270204 A1
(43) Pub. Date: Oct. 30, 2008

(54) Method and Arrangement for Arranging Practical Aspects of a Demand Responsive Transport System

(75) Inventors: Sami Poykko, Espoo (FI); Ville Ruutu, Espoo (FI); Jukka-Pekka Salmenkaita, Helsinki (FI)

Correspondence Address: YOUNG & THOMPSON, 209 Madison Street, Suite 500, ALEXANDRIA, VA, 22314, US

(73) Assignee: ECOLANE FINLAND OY, Espoo (FI)

(21) Appl. No.: 11/913,346

(22) PCT Filed: May 2, 2005
(86) PCT No.: PCT/FI2005/000204

§ 371 Date: Apr. 3, 2008

(51) Int. Cl. G06Q 10/00; G06Q 30/00

(52) U.S. Cl. 705/7

(57) ABSTRACT

Records are produced describing how a passenger uses a transport system in relation to other passengers. A transport server (1001) receives (203, 401) an identifier of a requested drop-off point and determines (204, 205, 403, 407) an identifier of a requested pick-up point. It also determines (405, 413, 803) a list of stopping point identifiers, which list includes the identifiers of the requested pick-up and drop-off points and constitutes an itinerary for a transport vehicle. A list of those passengers is determined (804) that have requested transport in the same vehicle. For each passenger on the list of passengers, there is determined (801, 804, 901, 904) which passenger-specific group of legs between stopping points belong to the transport requested by that passenger, and calculated (802, 805, 806, 807, 808, 902, 904, 905, 906, 907) a record that represents the relation between the passenger-specific group of legs and those other groups of legs that are specific to other passengers.

### TECHNICAL FIELD

The invention concerns generally the technical means required for enabling passengers to share transportation effectively and conveniently. Especially the invention concerns solutions to problems of handling order messages in an effective and convenient way, as well as creating, maintaining and processing information that can be used as a basis for an equitable way of pricing in shared transportation.

### BACKGROUND OF THE INVENTION

Public transportation is basically ride sharing, meaning that people travelling into the same direction at the same time share a transport vehicle with each other. The difficulty of arranging effective public transportation is the task of matching the needs of different passengers in an optimal way so that each passenger would experience public transportation as flexible and convenient. A large majority of people would like to have as much freedom as possible in organising their daily life, which contradicts with the traditional public transportation prerequisite of laying down fixed timetables and routes for the transport vehicles. The incapability of public transport systems in offering enough flexibility tends to increase the popularity of using private cars, which in turn increases traffic congestion, pollution and overall losses on the level of national economy.

Yet another problem of public transportation is the question of equitable pricing. The usual way of determining charges is either to apply a fixed price throughout the coverage area of a public transport system or to set up a scheme of zones so that the price to be paid depends on the number of zones to be crossed. The fixed price alternative is simple but tends to discriminate passengers that only want to take a relatively short ride. The zones alternative is more equitable in terms of congruence between the price and the length of the ride, but it often makes the charging system appear as complicated and tempts passengers to pay less than they actually should, through pretending to only cross a small number of zones.

Unanimity usually prevails about each user only having to pay according to his actual use of the public transport system. Similarly it is a general aim of all public transport operators to offer enough routes and departures so that at least a large majority of passengers could find choice exactly matching their needs. A system that would fulfil all these objectives can be generally designated as a demand responsive transport system. However, even if the principal questions about willingness of setting up a demand responsive transport system had been solved, there remains the technical problem of how to produce and dynamically monitor the information about transportation needs and usage of the system. A transport system is truly demand responsive only if it can adapt its operation to the changing needs of a large number of passengers in real time.

### SUMMARY OF THE INVENTION

It is an objective of the invention to present a method and an arrangement for producing real-time location-specific information about the needs of the users of public transport system, as well as the realisation of their use of the system. Location specificity is taken to mean that the system gets information about from where to where passengers would like to go, and what kinds of rides did they actually take on board of the public transport system. It is a further objective of the invention to enable the public transport system to control the movements of transport vehicles and to charge the users according to information of said kind.

The objectives of the invention are achieved by acquiring information about the real-time location of users through the functioning of their mobile communication terminals, as well as by setting up a centralised calculating system that takes into account the realised route of each transport vehicle as well as its occupancy between stops.

A method according to the invention comprises the steps of:
receiving from a terminal device of a passenger an identifier of a requested drop-off point,
determining an identifier of a requested pick-up point from which said passenger wants to be transported to said drop-off point,
determining a list of stopping point identifiers, which list includes the identifiers of said requested pick-up and drop-off points and constitutes an itinerary for a transport vehicle,
determining a list of passengers that have requested transport between stopping points the identifiers of which appear on said list, and
for each passenger on said list of passengers, determining which passenger-specific group of legs between stopping points belong to the transport requested by that passenger and calculating a record that represents the relation between the passenger-specific group of legs and those other groups of legs that are specific to other passengers on said list of passengers.

An arrangement according to the invention is basically an apparatus adapted to execute said method. The characteristic features of the arrangement comprise:
reception means adapted to receive identifiers of requested drop-off points from terminal devices of passengers,
pick-up point determining means adapted to determine an identifier of a requested pick-up point from which a passenger that has requested a drop-off point wants to be transported to said drop-off point,
stopping point list determining means adapted to determine a list of stopping point identifiers, which list includes the identifiers of requested pick-up and drop-off points and constitutes an itinerary for a transport vehicle,
passenger list determining means adapted to determine a list of passengers that have requested transport between stopping points the identifiers of which appear on a determined stopping point list, and
means for determining, for each passenger on a certain list of passengers, which passenger-specific group of legs between stopping points belong to the transport requested by each passenger and calculating a record that represents the relation between the passenger-specific group of legs and those other groups of legs that are specific to other passengers on said list of passengers.

Additionally the invention applies to a computer program product, which comprises:
computer code means adapted to receive and handle identifiers of requested drop-off points from terminal devices of passengers,
computer code means adapted to determine an identifier of a requested pick-up point from which a passenger that has requested a drop-off point wants to be transported to said drop-off point,
computer code means adapted to determine a list of stopping point identifiers, which list includes the identifiers of requested pick-up and drop-off points and constitutes an itinerary for a transport vehicle,
computer code means adapted to determine a list of passengers that have requested transport between stopping points the identifiers of which appear on a determined stopping point list, and
computer code means for determining, for each passenger on a certain list of passengers, which passenger-specific group of legs between stopping points belong to the transport requested by each passenger and calculating a record that represents the relation between the passenger-specific group of legs and those other groups of legs that are specific to other passengers on said list of passengers.

The route of a transport vehicle is a chain-like series of legs between stops. At each stop some number of passengers may get in and some number of passengers may get out. From the viewpoint of an individual passenger the ride has a starting point and an endpoint, with a non-negative number of stops therebetween. The location of the starting point and the endpoint are important to the individual passenger, while the location of stops therebetween are not, as long as they are not prohibitively far from the direct route so that going through the intermediate stops would make the ride much longer. On each leg the individual passenger shares the transport vehicle with a variable number of fellow passengers. According to the first aspect of the invention there is created a leg-specific occupancy record for each leg of the transport route, which occupancy record shows, which passengers were on board the transport vehicle during that leg. Optionally the occupancy record can be weighted with values showing the length of the leg. From the occupancy records and the total length of the route certain proportional factors can be calculated that show, what was the relative amount of using the transport service for each passenger.

For monitoring the location-specific needs and usage it is convenient to use a so-called location request functionality that is presently in the process of being built as an integral part to mobile communication systems. A centralised server may initiate requesting the location of a certain mobile communication terminal and get a response revealing the requested location in real time. Since the mobile communication terminal is nearly always at the same place as its user, the location-specific information collected this way can be used in controlling the operation of a demand responsive transport system.

### BRIEF DESCRIPTION OF DRAWINGS

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

FIG. 1 illustrates a system-level framework of the present invention,

FIG. 2 illustrates the main steps of preparing for transport,

FIGS. 3a-3d illustrate various ways of requesting location,

FIGS. 4a-4b illustrate various method aspects of the invention,

FIGS. 5a-5b illustrate certain aspects of an exemplary transport itinerary,

FIGS. 6a-6b illustrate certain aspects of another exemplary transport itinerary,

FIG. 7 illustrates the concept of a fare calculation window,

FIGS. 8a-8b illustrate various method aspects of the invention,

FIG. 9 illustrates retrospective fare calculation and compensation,

FIG. 10 illustrates an arrangement according to an embodiment of the invention, and

FIG. 11 illustrates a computer program product according to an embodiment of the invention.

### DETAILED DESCRIPTION OF THE INVENTION

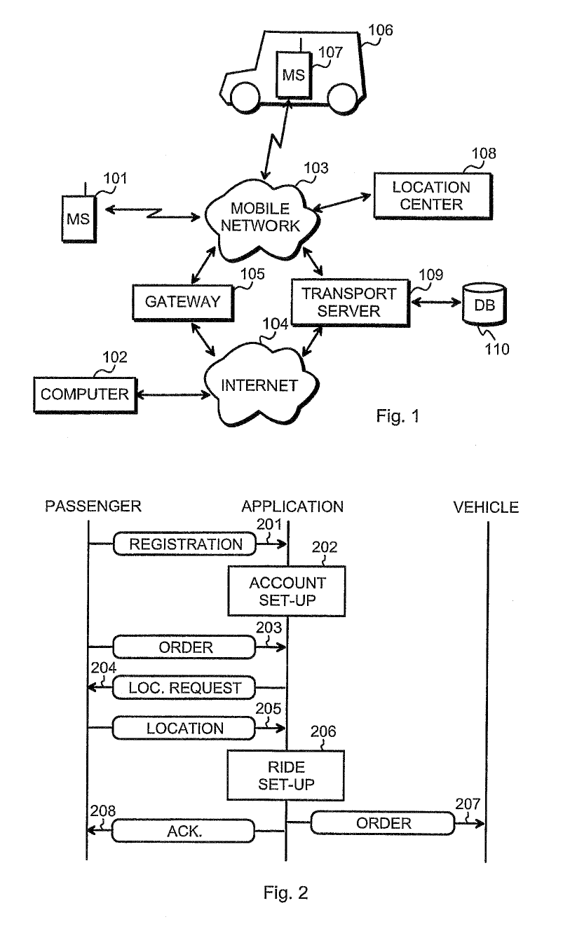

FIG. 1 is a schematic illustration of certain relevant parts of a system for arranging demand responsive transportation. A passenger has a mobile station 101, and typically also a computer 102, at his disposal. The mobile station 101 is wirelessly coupled to a cellular radio network 103 and the computer 102 is in this example wired to the Internet 104. Gateway computers 105 between cellular radio networks 103 and the Internet 104 on one hand and various wireless network extensions (not shown in FIG. 1) on the other hand make it also possible to a computer like that 102 shown in FIG. 1 to act as a mobile station or mobile terminal; likewise a mobile station like that 101 shown in FIG. 1 may take the role of a passenger's computer. A transport vehicle 106 is also equipped with a mobile station 107. The location of mobile stations 101, 107 belonging to the cellular radio network 103 can be tracked in a location center 108. For tracking the location of certain types of mobile stations that have inherent self-positioning capability not even a separate location center is necessary: the location of such a mobile station can be tracked simply by requesting the mobile station to self reveal its position in real time. An example of such a mobile station is the “Esc! NT2002” model manufactured and marketed by Benefon Oyj, Finland. “Esc!” and “Benefon” are registered trademarks of Benefon Oyj.

The central controlling and processing station of the demand responsive transport system is a transport server 109, which is equipped with a database 110 for storing information about passengers, vehicles, routes and usage of the demand responsive transport system. In the exemplary solution of FIG. 1 the transport server 109 has direct connections to both the cellular radio network 103 and the Internet 104. The purpose of the connection to the cellular radio network 103 is to enable direct communication to and from the mobile stations 101, 107 and the location center 108 for the purposes described in more detail later. The Internet connection enables passengers to use browser programs running in their computers to contact the transport server 109.

FIG. 2 is an illustration of certain steps taken before a passenger may take a ride in the demand responsive transport system. At step 201 the passenger registrates as a user of the system. The registration step typically involves the passenger using a browser program running in a computer to contact the transport server. The transport server presents a certain input form, into which the passenger inserts requested information about his identity and the way in which payment for the passenger's usage of the system will be effected. The transport server stores information given by the passenger into a passenger database at step 202, thus setting up a user account for the passenger.

As a part of the registration and account set-up steps 201 and 202 it is advantageous to allow the passenger to reserve certain shorthand notations, which indicate locations at which the passenger will typically want to get on or off a transport vehicle. These notations should be as short and concise as possible, because during his use of the transport system the passenger will repeatedly be inputting them through the user interface of a mobile station. At least the present-day user interfaces of mobile stations tend to make inputting character strings somewhat cumbersome. Most advantageously the shorthand notations are classified into at least two classes, which are the “passenger-specific” and “generally used” classes. For example “HOME” is a typical passenger-specific shorthand notation, which for each passenger means a different physical location, while “OPERA” is an example of a generally used shorthand notation. There can even be “group-specific” short-hand notations like “WORK”, which means the same place for all employees of one company but a different place for those of another company.

At some later moment the passenger sends an order message 203 to the transport server. The meaning of the order message 203 is to indicate the passenger's need for a ride, which need may be immediate or timed to occur at certain well-defined future instant of time. In the most typical case the order message 203 comes from the mobile station of the passenger and has e.g. the form of an SMS message, where SMS comes from Short Messaging System. The invention does not exclude other kinds of order messages, such as those given through a WAP connection, a data call or a voice call. The essential content of the order message 203 is an indication about from where to where the passenger would like to go. A typical example of an order message utilising shorthand notations could be “HOME>>WORK”.

According to an aspect of the invention the transport server responds to receiving the order message by requesting the location of the user at step 204. As a response the user indicates his current location at step 205. In FIG. 2 the location request 204 and the location response 205 appear schematically as going between the transport server to the user; various alternative practical implementations are discussed later. Most advantageously steps 204 and 205 do not require any attention from the human user himself, but are performed automatically by the appropriate electronic devices.

The essential result of requesting and indicating the location is that after step 205 the transport server knows that the passenger is at a certain location, which may also be the location at which the passenger wants to get on board a transport vehicle. Other possibilities are discussed later. As a result of previously receiving an indication of the step-off location at step 203 the transport server also knows the location at which the passenger would like to get off the transport vehicle. At step 206 the transport server makes certain preparatory processing for planning the passenger's trip. The exact nature of such processing is explained later. One result of the processing is selecting a transport vehicle that will provide the requested service. At step 207 the transport server issues a corresponding service order to a transport vehicle. In order not to leave the passenger in uncertainty about whether his transport order has been accepted or not, the transport server sends an acknowledgement message to the passenger at step 208.

Let us consider in more detail the steps of requesting and indicating the location of the passenger (steps 204 and 205 in FIG. 2). According to an aspect of the invention there are two uses for these steps. The first alternative is to allow the passenger to make his transport request beforehand, while he is not yet at the location at which he would like to enter the transport vehicle. When the transport server notices a discrepancy between the location that appeared in the transport order and that received as a response to the location request, it knows not to send a transport vehicle to the passenger immediately. The actual moment when the passenger should meet the transport vehicle at the ordered pick-up location can then be estimated in many ways: for example the transport server may calculate the physical distance between the ordered pick-up location and the current location of the passenger and map the calculated distance into an estimated time by using a look-up table, which assumes the passenger to advance from his current location towards the ordered pick-up location at some constant speed. The transport server may also respond to a noticed location discrepancy by sending the passenger an inquiry, requesting the passenger to announce the time at which pick-up should take place. Another possibility is that the transport server repeats the location request after a short while, gets another location indication of the passenger, and investigates whether the passenger has arrived at or at least approached the ordered pick-up location. From repeated rounds of requesting the location of the passenger the transport server can easily make an estimate, when the passenger will be at the ordered pick-up location.

A yet further option is that the order message may already contain an indication about the desired pick-up time, and only optionally the desired pick-up location. If the order message contains such a desired pick-up time, which at the time of receiving the order message at the transport server is farther in the future than a certain predefined limit, the transport server may decide to defer any location requests until a certain moment when the desired pick-up time is closer. Then after the transport server has finally decided to start requesting for location, depending on whether the “well in advance” order message included the desired pick-up location or not the procedure may proceed as is described otherwise in this description.

The alternative use of requesting the location of the passenger is to allow the passenger to leave out any explicit indication of pick-up location from the original order message. Instead of sending an order message “HOME>>WORK” the passenger should send just “>>WORK”. Then the transport server would request the location of the passenger, consult a database of possible stopping points to find the point nearest to the passenger's indicated location where a transport vehicle could stop, and announce it as the selected pick-up point to both the transport vehicle and the passenger. The database of stopping points may include stopping points that have already been defined as points where a transport vehicle will stop anyway in the next few moments because of other, already processed transport orders. Alternatively or additionally the database of stopping points may be a list of all those points where convenient stopping of a transport vehicle is possible in any case. A third possibility is that the points are defined as common locations for an organization, office names etc.

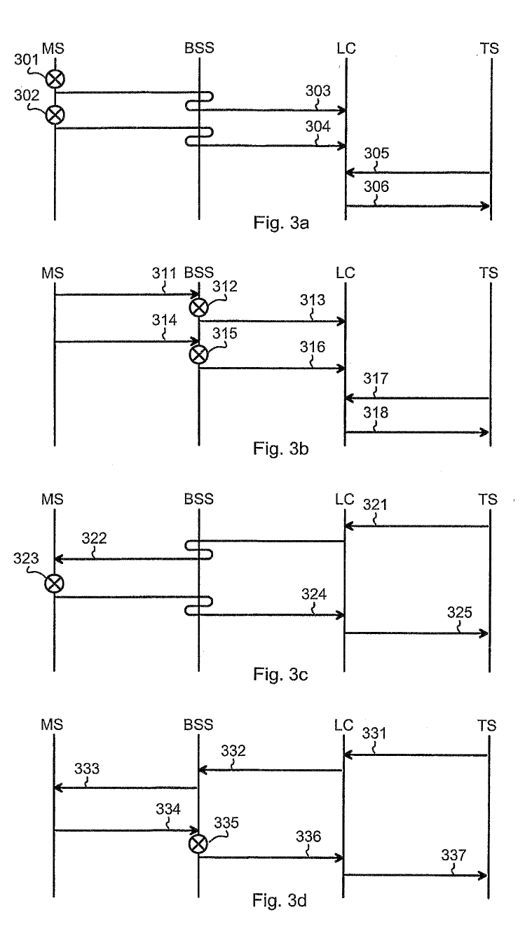

FIGS. 3a to 3d illustrate certain exemplary ways of how the process of requesting and indicating the location of a passenger can proceed. FIG. 3a illustrates a case in which the mobile station MS automatically determines its location every now and then at steps 301 and 302 and announces the determined location by transmitting it in a message through the base station subsystem BSS to the location center LC at steps 303 and 304 respectively. When the transport server TS wants to know the location of a passenger, it sends a request 305 to the location center, which responds at step 306 with the latest known location of the passenger. In FIG. 3b the situation is otherwise the same but the responsibility of automatically determining the location of a mobile station is on the base station subsystem. When the mobile station makes a certain transmission at step 311, the base station sub-system receives it and determines the location at step 312 for example by triangular measurements and sends the determined location to the location center at step 313. A similar procedure is repeated at steps 314, 315 and 316. Step 317 is a location request from the transport server and step 318 is the corresponding response.

FIG. 3c assumes that the mobile station will only determine and announce its location per request. At step 321 the transport server requests the location, which causes the location center to transmit, through the base station subsystem, a location determining and announcing request to the mobile station at step 322. The last-mentioned determines its location at step 323 and announces it in a message to the location center at step 324. The transport server gets its requested location information at step 325. If the mobile stations can be directly requested to reveal their location without the involvement of a location center, the arrows at steps 321 and 325 would go directly between the transport server and the mobile station. The procedure of FIG. 3d again shows an alternative in which the base station sub-system determines the location, possibly after a prompt for transmission has been delivered through steps 331, 332 and 333, and after the mobile station had produced a transmission at step 334 that enables determining its location at step 335. Steps 336 and 337 represent forwarding the determined location to the transport server.

As was pointed out earlier, in FIGS. 3a, 3b, 3c and 3d the transport server may send its (first) location request (steps 305, 317, 321 and 331) either immediately having received a transport order or, if for example the transport order was of the “well in advance” type, only after a certain delay. In the last-mentioned case the purpose is to avoid unnecessary location requests when it is clear that they would be of no use concerning the ordered transport.

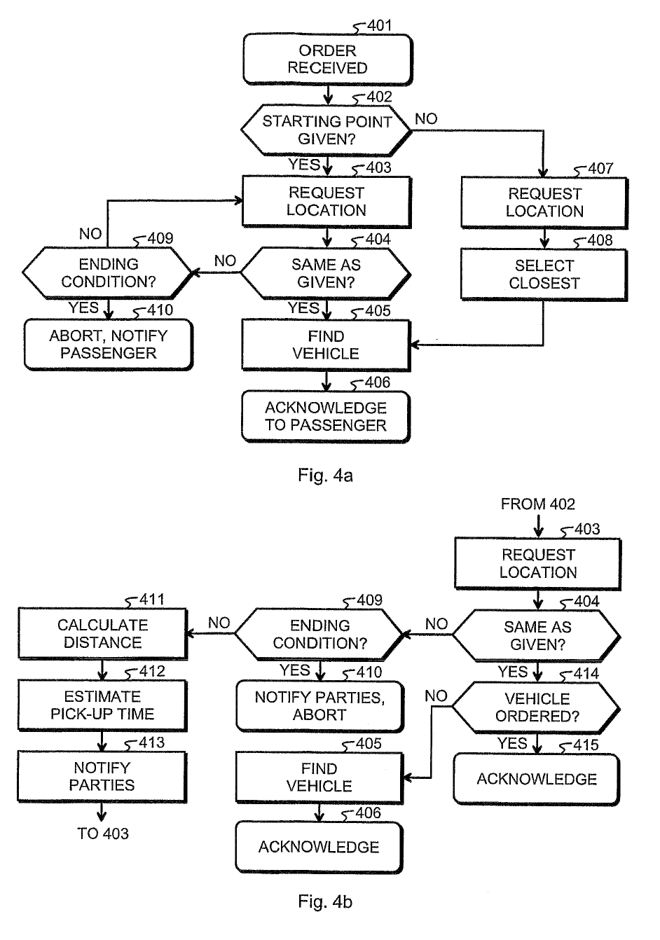

FIG. 4a illustrates a simple embodiment of a method applied in the operation of a transport server with respect to handling transport orders. Operation begins at step 401 by receiving a transport order. At step 402 the transport server checks, whether the transport order contains an indication of a pick-up location. If it does, the transport server next requests the current location of the passenger at step 403. Between steps 402 and 403 there may be a considerable delay, if the transport order was of the “well in advance” type. After having received the location the transport server checks at step 404, whether the current location is the same as the ordered pick-up location. If it is, the transport server proceeds to step 405, where it finds a suitable vehicle for delivering the ordered transport and communicates a ride order to the selected vehicle. Suitability of a vehicle is defined so that either at least one of the presently requested pick-up and drop-off points already appear in the itinerary of a vehicle, or adding them to the itinerary composed so far does not make large additional detours. At step 406 operation terminates by sending the passenger an acknowledgement to indicate that an ordered vehicle is on its way.

If the transport order did not contain an indication of a desired pick-up location at step 402, the transport server requests the location at step 407 and selects the pick-up location at step 408 to be the closest possible vehicle stop location found in its route database. Operation then proceeds again to selecting and ordering a vehicle at step 405 and acknowledging the successful ordering to the passenger at step 406. This time it is advantageous to announce in the acknowledgement message the selected pick-up location, so that the passenger knows to go to the right location.

If the transport server found at step 404 that the passenger is not currently at the ordered pick-up location, it checks at step 409 whether it can continue making further location requests. A condition that could prohibit further requests could be e.g. the fact that the passenger has only authorised the system to track his location for a limited duration of time, which has already run out. Alternatively the system may have been configured to only request the passenger's position for a limited number of times, which have all been used already. In a very simple alternative the system might even only accept transport orders sent from the exact pick-up location, in which case operation would always proceed from step 409 to aborting at step 410. If none of such conditions prohibit continued operation, the transport server returns to step 403 and circulates the loop of steps 403, 404 and 409 until the passenger either arrives at the pick-up location or some ending condition is fulfilled. In all cases of aborting it is advisable to notify the passenger that pick-up will not take place.

FIG. 4b illustrates an alternative to the lower left part of the flow diagram of FIG. 4a. In FIG. 4b steps 403, 404, 409 and 410 are exactly the same as in FIG. 4a. However, in the absence of any fulfilled ending conditions in step 409 the transport server proceeds to step 411 to calculate the distance between the ordered pick-up location and the passenger's current location. It uses the calculated distance (and possibly any existing knowledge of previously calculated distances and thus the speed at which the passenger is approaching the pick-up location) to estimate a pick-up time at step 412. At step 413 it announces the estimated pick-up time to the passenger and the selected vehicle. Step 413 is important especially during the first time of going through the estimation procedure, since this embodiment assumes that the transport server will select and reserve the transport vehicle beforehand, immediately after having received the transport order even if the passenger is not yet there. Taken this assumption, the first time of going through step 413 is the occasion at which the vehicle is selected and reserved. During the consequent estimation rounds it is actually not necessary to announce anything at step 413, at least if the newest estimation has not changed the time radically.

After step 413 the transport server returns to step 403, from which further rounds through steps 404, 409, 411, 412 and 413 follow until the passenger arrives at the pick-up location or an ending condition triggers abortion at step 409. Assuming the former, there is needed a further check at 414 regarding whether a vehicle was ordered already: if the transport order came from the pick-up location, there was never any branching from step 404 to step 409 and a vehicle must be found and ordered according to step 405. Steps 405 and 406 are thus the same as in FIG. 4a, only appearing at a different part of the flow diagram. If a vehicle was already ordered, operation proceeds from step 414 where the transport order announces, advantageously both to the passenger and to the vehicle, that according to its knowledge the passenger was now ready to be picked up.

Next the problems related to fare calculation are discussed. Shared transportation (bus, minibus, shared taxi, car pool or the like) is a competitive alternative to personal transportation (private car, own taxi) if at least one of the following conditions is met:
the distance that a passenger must travel within the vehicle is not considerably longer than the direct distance between the passenger's desired starting point and endpoint (in this context, the concept of distance refers to a traversable path connecting the desired starting point and endpoint on the road network, not the line of sight distance)
the extra distance that a passenger must go between his desired starting point and a pick-up location, as well as between the drop-off location and the desired endpoint, is not long
the cost of the shared transportation is remarkably lower than that of private transportation
the time difference between the passenger's most suitable departure time and that offered by shared transportation is not large.

The better the conditions above are met, the more attractive is the shared transportation alternative. If one of the conditions is particularly well met, e.g. if shared transportation costs significantly less than private transportation, passengers are typically willing to even compromise the others. The fare calculation aspect of the present invention aims at providing a fare calculation scheme that would be equitable enough to be accepted by all passengers, independently of the length of their ride in the shared transport vehicle.

In general it is possible to represent the fare Fᵢ that an i:th passenger has to pay for his trip according to the equation

Fᵢ=Sᵢ+cᵢPᵢ (1)

where Sᵢ is a flat rate independent of the length of the trip, Pᵢ is a parameter proportional to the length of the trip and cᵢ is a constant. The formula (1) is very adaptable and allows all kinds of pricing schemes to be implemented, ranging from a constant price for all (cᵢ≡0 for all i) to completely trip length dependent options (Sᵢ≡0 for all i). Having the index i in all terms signifies the fact that the rules for determining the fare may be even different for all passengers. This way the formula (1) can take into account e.g. discounts based on long-term subscriptions to the system, passenger disability, membership to various groups and associations, employer subvention and other factors. Regular users of the shared transport system may pay a certain fee to obtain a fixed-term subscription, during which they can use the system freely, while more irregular users pay on a per order basis.

The parameterised fare calculation formula (1) can also be used to offer different fare alternatives as a response to a single transport order, if the demand responsive transport system can offer several alternative rides. Typically such alternative rides can be ordered according to some Quality of Service (QoS) criterion, examples of which include geographical directness, expected time to be spent en route, time to be waited before pick-up and distance from ordering location to pick-up point. It is also typical that if the passenger does not insist upon the shortest and most readily available trip but accepts a lower QoS in terms of criteria like those mentioned above, the system may place him into some already arranged transport vehicle that will be passing by anyway, in which case the extra cost to the system is small and also the passenger may be offered a lower fare.

A yet another feature of parameterisation is that the fare calculated for a certain passenger with certain parameter values can be treated as the maximum or “worst-case” fare, which the passenger will have to pay if there will not come any other passengers to the same transport vehicle than what the system is currently aware of. During and immediately after the trip the passenger may receive pleasant surprises saying that since more passengers came to the same transport vehicle after the initial transport order, the actual fare will be lower than what was initially announced. The implementation of such a calculating and re-calculating scheme only requires that there are co-passenger dependent definitions for the parameter values.

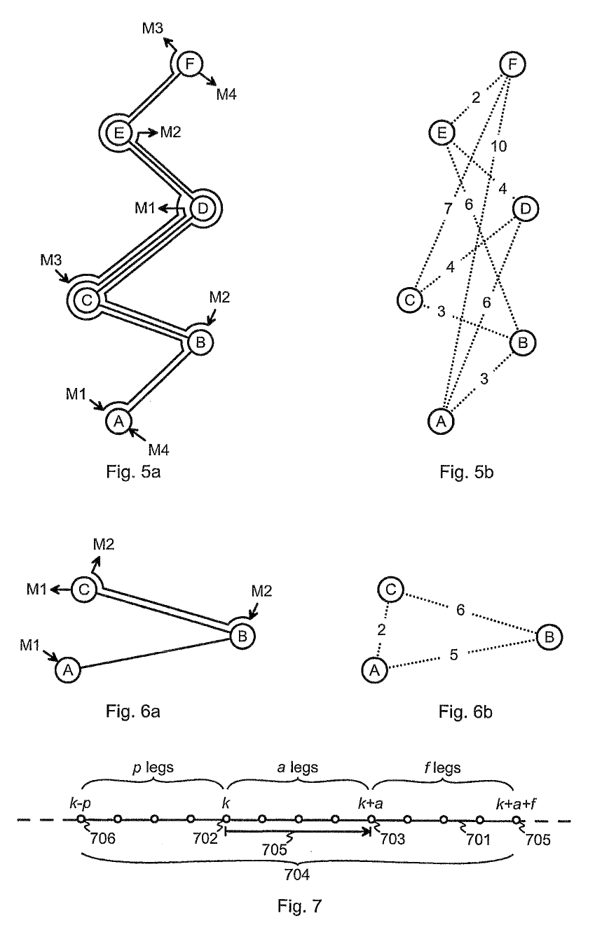

FIG. 5a illustrates a situation in which there are four passengers M1, M2, M3 and M4; and six locations A, B, C, D, E, and F that appear in their transport orders. Passenger M1 wants to go from A to D, passenger M2 from B to E, passenger M3 from C to F and passenger M4 all the way from A to F. FIG. 5b illustrates the direct distances that will be involved in the calculations: the distances are A-B 3 units, B-C 3 units, C-D 4 units, D-E 4 units, E-F 2 units, A-D 6 units, B-E 6 units, C-F 7 units and A-F 10 units. Said distances can represent physical distance, but equally well e.g. travelling time where road and traffic conditions were taken into account, or travelling cost that would include bridge tolls, motorway charges and other cost-affecting factors. In the following we will designate the distances with d.

We may first assume, as a starting point for comparisons, that there were no demand responsive transport system at all and each passenger had to take a taxi of their own. In this case Pᵢ≡dᵢ for all i. Assuming that the pricing of ordinary taxis involves a certain fixed flat rate S_{TAXI} and a certain proportionality constant C_{TAXI} for the dependency of trip length, we get the following table:

TABLE 1
no shared transportation

| | Pᵢ (≡dᵢ) | Fare |
|---|---|---|
| M1 | 6 | S_{TAXI} + 6c_{TAXI} |
| M2 | 6 | S_{TAXI} + 6c_{TAXI} |
| M3 | 7 | S_{TAXI} + 7c_{TAXI} |
| M4 | 10 | S_{TAXI} + 10c_{TAXI} |

We will now consider certain formulas for calculating equitable fares for the passengers in the case of taking a shared transport vehicle. The first alternative is to calculate the length of the whole trip that the shared transport vehicle will make, and derive passenger-specific Pᵢ values therefrom by scaling the total length with the relative usage of each passenger. This first calculation alternative can be expressed as

$${P}_{i} = \frac{{d}_{i}}{{\sum }_{j} {d}_{j}} {\sum }_{l} {D}_{l} \qquad ( 2 )$$

where the summing over index j means summing over all passengers taking this particular transport vehicle, Dᵢ is the length of the i:th leg of the route and the summing over index I means summing over all legs of the route. For the exemplary case of FIGS. 5a and 5b,

$${\sum }_{l} {D}_{l} = 3 + 3 + 4 + 4 + 2 = 16$$

and

$${\sum }_{j} {d}_{j} = 6 + 6 + 7 + 10 = 29.$$

respectively we get the following table for the Pᵢ values and fares.

TABLE 2
first calculation alternative

| | dᵢ | Pᵢ | Fare |
|---|---|---|---|
| M1 | 6 | 3.31 | S_{SH} + 3.31c_{SH} |
| M2 | 6 | 3.31 | S_{SH} + 3.31c_{SH} |
| M3 | 7 | 3.86 | S_{SH} + 3.86c_{SH} |
| M4 | 10 | 5.52 | S_{SH} + 5.52c_{SH} |

Here we have used the index SH to mean that the S and c values are those related to shared transportation. It is natural to assume that the flat rate part (the S part) of the fare should correspond to certain fixed expenses that the transport operator has for maintaining a transport vehicle. In this exemplary case we may well set S_{SH}=0.25 S_{TAXI} or more generally S_{SH}=(S_{TAXI}/ΣM), where ΣM is the number of passengers taking the same vehicle, since the transport operator only has to maintain a single vehicle, the fixed expenses of which are carried in equal parts by all passengers. Now even if the proportionality constant for the length-dependent part of the fare is the same as for separate taxis (C_{SH}=C_{TAXI}) without any dependency on passenger, it is easy to note that all passengers get their ride much cheaper than if they all took separate taxis.

In the first calculation alternative above, the scaling of the Pᵢ values takes into account the lengths of the legs travelled by each passenger. A second calculation alternative is otherwise similar, but the weighting is made simply on the basis of occupancy, i.e. on the basis of whether a passenger was in the vehicle during a certain leg. As a calculational aid we define an occupancy parameter Oⱼᵢ, the value of which is 1 if the j:th passenger was in the vehicle during the l:th leg, and 0 otherwise.

TABLE 3
occupancy in the exemplary case of FIGS. 5a and 5b

| | leg 1 | leg 2 | leg 3 | leg 4 | leg 5 |
|---|---|---|---|---|---|
| M1 | 1 | 1 | 1 | 0 | 0 |
| M2 | 0 | 1 | 1 | 1 | 0 |
| M3 | 0 | 0 | 1 | 1 | 1 |
| M4 | 1 | 1 | 1 | 1 | 1 |

According to said second calculation alternative the formula for calculating the Pᵢ values is

$${P}_{i} = {\sum }_{l} ( \frac{{O}_{il}}{{\sum }_{j} {O}_{jl}} {D}_{l} ) \qquad ( 3 )$$

where the summing over index j in the denominator means summing over all passengers taking this particular transport vehicle, Dₗ is again the length of the l:th leg of the route and the summing over index l means summing over all legs of the route. Applying formula (3) to the exemplary case of FIGS. 5a and 5b gives the following Pᵢ values and fares.

TABLE 4
second calculation alternative

| | dᵢ | Pᵢ | Fare |
|---|---|---|---|
| M1 | 6 | 3.50 | S_{SH} + 3.50c_{SH} |
| M2 | 6 | 3.33 | S_{SH} + 3.33c_{SH} |
| M3 | 7 | 3.33 | S_{SH} + 3.33c_{SH} |
| M4 | 10 | 5.83 | S_{SH} + 5.83c_{SH} |

The second calculation alternative tends to reward passengers that take only legs where also a large number of other passengers are present, and charge those passengers more that happen to be alone or in the company of only few others for a large part of the trip.

FIGS. 6a and 6b illustrate a case in which passenger M1 is going from A to C and passenger is going to B to C. The shared transport vehicle picks passenger M1 from A, drives to B to pick passenger M2, and drops both off at C. This time the direct distances are A-B 5 units, B-C 6 units and A-C only 2 units. The Pᵢ values given by the first and second calculation alternatives above are as follows.

TABLE 5
Pᵢ values in the case of FIGS. 6a and 6b

| | dᵢ | Pᵢ (1st alt.) | Pᵢ (2nd alt.) |
|---|---|---|---|
| M1 | 2 | 2.75 | 8.00 |
| M2 | 6 | 8.25 | 3.00 |

It is easy to see that none of the calculation alternatives shown so far is perfect for the situation of FIGS. 6a and 6b. At first sight the values in table 5 would suggest that each alternative could easily result in both passengers paying more for their shared transportation than what separate taxis would cost them. Particularly if the second calculation alternative was used, passenger M1 would not be too pleased with having to pay a multiple of the price of a short, direct taxi ride. In general terms we may say that in the example of FIGS. 6a and 6b the shared transport system was unsuccessful in combining the rides: the disadvantageous conditions that the passengers were to face resulted from taking a too winding route with too few passengers sharing the cost.

There are several alternative strategies of preparing for situations like that shown in FIGS. 6a and 6b. The simplest of them is to set a universal condition

Pᵢ≦dᵢ (4)

which in other words says that the trip length dependent parameter Pᵢ is either the result given by the applicable one of formulas (2) or (3), or equal to the shortest length dᵢ of a direct taxi ride, whichever is smallest. Another alternative strategy is to select the values S_{SH} and C_{SH} small enough so that even if the parameter Pᵢ was larger than the shortest direct distance dᵢ, the calculated fare would remain lower than what a direct taxi ride would cost. Assuming again S_{SH}=(S_{TAXI}/ΣM) and requiring the fare S_{SH}+8.00 c_{SH} of passenger M1 to be lower than S_{TAXI}+2 c_{TAXI} results in a condition that c_{SH} should be lower than approximately one quarter of C_{TAXI}.

A yet further alternative strategy for preventing unreasonable fare prices in exceptional cases is to tune the calculation algorithm of the Pᵢ values so that if a passenger's shared transport ride is much longer than the shortest direct length to his destination, this is automatically compensated for in the Pᵢ value. This can be done for example by writing into the formulas of the Pᵢ value an additional term that expresses the relative amount of additional distance to be travelled. Tuning the formulas (2) and (3) respectively this way would result e.g. in formulas

$${P}_{i} = \frac{{d}_{i}}{{\sum }_{l} {O}_{il} {D}_{l}} \frac{{d}_{i}}{{\sum }_{j} {d}_{j}} {\sum }_{l} {D}_{l} \qquad ( 5 )$$

$${P}_{i} = \frac{{d}_{i}}{{\sum }_{l} {O}_{il} {D}_{l}} {\sum }_{l} ( \frac{{O}_{il}}{{\sum }_{j} {O}_{jl}} {D}_{l} ) \qquad ( 6 )$$

where

$${\sum }_{l} {O}_{il} {D}_{l}$$

is simply an expression for the length of the i:th passenger's shared transport ride. Using formulas (5) and (6) to recalculate the Pᵢ values in the case of FIGS. 6a and 6b gives the following results.

TABLE 6
tuned Pᵢ values in the case of FIGS. 6a and 6b

| | dᵢ | Pᵢ (form. 5) | Pᵢ (form. 6) |
|---|---|---|---|
| M1 | 2 | 0.50 | 1.45 |
| M2 | 6 | 8.25 | 3.00 |

The Pᵢ values of passenger M2 do not change from those of table 5, because for his part the length of the shared transport ride is the same as the shortest direct distance dᵢ, and the additional term written into the calculation formulas is thus equal to one.

A basic question of calculating the fare for a shared transport ride is, whether the fare calculated for a certain i:th passenger should take into account passengers that will get on board the transport vehicle after said i:th passenger has been already dropped off, or the other way round, whether those passengers should be taken into account who had already left the vehicle when the i:th passenger was picked up. If the fare must be paid e.g. to the driver when leaving the vehicle at the latest, it is naturally impossible to take into account any possibly oncoming transport orders for the same vehicle. If, on the other hand, the system calculates the actual fares afterwards and just debits the passengers' user accounts correspondingly, it is possible to utilise certain accumulated knowledge about how popular the same transport vehicle was later (and also earlier) than just during the ride of a certain passenger.

Conventional buses usually have fixed one-way routes. After having reached the terminal point the bus turns around and drives more or less the same route backwards. If we think about a demand responsive transport system according to roughly the same model, the most readily occurring viewpoint for fare calculations is to only take into account those passengers that took the same vehicle on its current one-way trip from a starting point to a terminal point through a route, only the exact form of which is determined dynamically by taking into account transport requests. As a comparison a taxi drives almost randomly to all directions, always picking up the next available transport order. If the transport vehicles of a demand responsive transport system should resemble taxis more than buses, it is not that clear, how many other passengers should be accounted for in fare calculations.

A concept that clarifies the fare calculation process is the fare calculation window, which can be defined simply as follows, with reference to FIG. 7. Let us assume that a transport vehicle drives along a route 701, stopping every now and then to pick up or drop off passengers. Whether said route is of the “bus” type or the “taxi” type discussed above is not important. The stopping points appear in FIG. 7 as small circles. Let us further assume that a certain passenger gets on board at a certain k:th stop 702, stays on board for a legs and thus steps out on the (k+a)th stop 703. Still further we assume that there are system parameters p and f that denote the number of preceding (p) and following (f) stops. The fare calculation window 704 of the shared transport ride 705 of said passenger ranges from the (k−p)th stop 706 to the (k+a+f)th stop 707. As a basis for fare calculation, one of the following approaches can be selected:
only those other passengers are taken into account that get on board the same transport vehicle within the fare calculation window
only those other passengers are taken into account that leave the transport vehicle within the fare calculation window
only those other passengers are taken into account that get on board or leave the same transport vehicle within the fare calculation window or
only those other passengers are taken into account that get on board and leave the same transport vehicle within the fare calculation window.

A reasonable minimum limit for both p and f is zero. Maximum values can be large enough to accommodate all legs that the transport vehicle covers during a one-way journey between terminal points, or even during one day. The optimal values can be selected within these limits according to system level considerations.

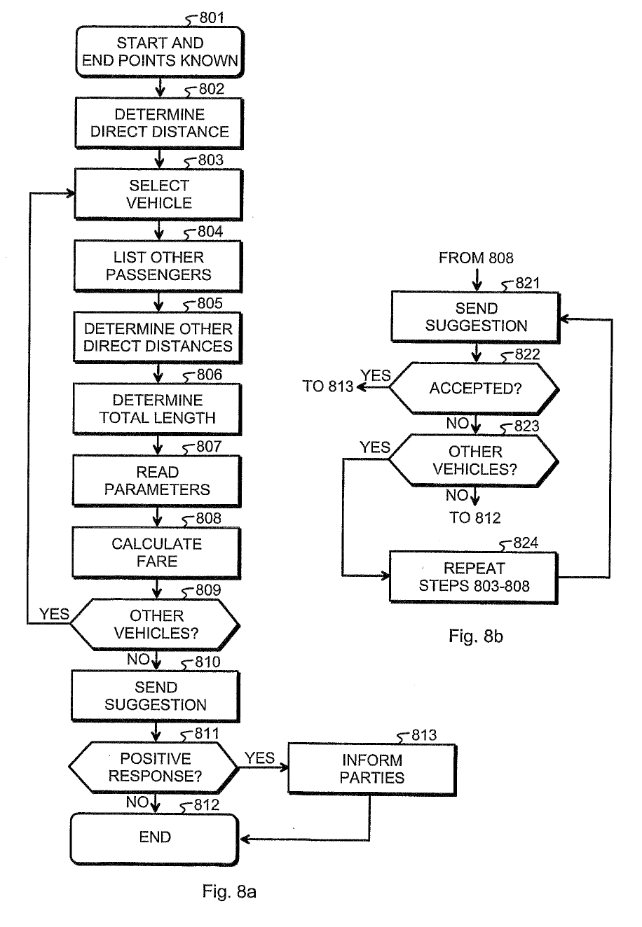

The formulas (2), (3), (5) and (6) can all be used both for calculating fares for real time payment and for calculating actual fares afterwards after the contribution of all other passengers is known. FIGS. 8a and 8b show certain exemplary features of applying formula (2) to the calculation of a fare during a process of setting up a requested ride. The procedure begins at step 801 with the assumption that the transport server knows the pick-up and drop-off points of the requested ride: the most typical case is that where the transport server has just received a transport request indicating the pick-up and drop-off points, or has received a transport request indicating a drop-off point and used a location request to determine a pick-up point. At step 802 the transport server determines the shortest direct distance, designated earlier as the dᵢ. At step 803 the transport server selects a vehicle that is to deliver the requested ride. Step 804 corresponds to consulting a transport memory to identify all those other passengers that are already known to take the same transport vehicle and to be within the transport window in the meaning of the selected one of the rules discussed earlier.

At steps 805 and 806 the transport server determines or reads from memory the dⱼ′s and calculates the sum of Dᵢs respectively. At step 807 the transport server determines or reads from memory the Sᵢ and cᵢ parameter values applicable in this calculation. In this advantageous embodiment of the invention these were not determined earlier, since their determination may be affected by the results obtained so far (for example: for rides for which the sum of Dᵢs exceeds a certain limit, select different parameter values). At step 808 the fare is calculated by using the information obtained so far and applying the appropriate calculating formula.

The process illustrated in FIG. 8a assumes that the transport server will try already at this stage to find possible alternative routes served by other vehicles. Therefore it checks at step 809, whether there are any alternatives not yet analysed. A positive finding at step 809 causes a return to step 803, while simultaneously keeping in memory all route and fare alternatives calculated so far. Only after no more alternative vehicles are found at step 809, the transport server proceeds to send information about the calculated route and fare alternatives to the passenger at step 810. If the passenger does not respond at step 811, the procedure ends at step 812. If the passenger responded at step 811 by accepting one of the suggested alternatives, the transport server sends a transport order to the appropriate vehicle and acknowledges successful transport allocation to the passenger at step 813.

FIG. 8b illustrates an alternative where, after having calculated a fare at step 808, the transport server immediately sends it as a suggestion to the passenger at step 821. If the passenger announces to accept the suggestion at step 822, procedure continues at step 813. If the passenger did not accept, the transport server tries at step 823 to find alternatives. If none are found, the procedure terminates at step 812. Finding an alternative at step 823 causes steps 803 to 808 to be repeated, after which the process continues from step 821.

It is possible that a passenger that has requested transport will never show up at the pick-up location and thus will not actually use his requested transport. The system must have a rule about charging or not charging for this kind of “no-show” behaviour. The simplest possible rules are either to charge for each ordered transport irrespective of whether the passenger actually showed up or not, or deliberately not charging anything from “no-show” passengers. The first-mentioned rule requires that there exists a system for charging fares without the physical presence of the passenger, for example by debiting a user account at the transport server. The second alternative requires either that passengers pay their fare to the driver of the transport vehicle, or that the transport server only debits a user account after having received a confirmation message e.g. from the driver. More complicated rules for “no-show” charging typically involve not charging the whole fare but only a certain lower penalty fare. All such systems require both the possibility of charging without physical presence and a way of confirming, whether the passenger actually got on board the vehicle. The detailed way in which these arrangements are implemented is outside the scope of the present invention.

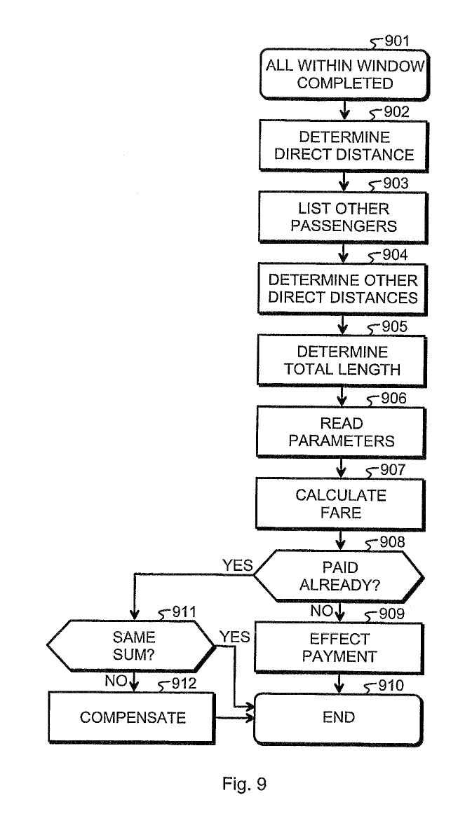

FIG. 9 is an exemplary illustration of applying formula (2) to the calculation of an actual fare afterwards. This procedure starts at step 901 when all factors affecting the calculation, i.e. the contribution of all relevant other passengers, is known. Steps 902, 903, 904, 905, 906 and 907 correspond closely to steps 802, 804, 805, 806, 807 and 808 in FIG. 8a. In the afterwards calculation of FIG. 9 there follows, after the step 907 of calculating a fare, a check at step 908 whether the passenger did already pay something for his trip. A negative finding at step 908 frequently occurs for example in cases where the fare calculation is only performed at the moment when the passenger is leaving the transport vehicle, and only those other passengers are taken into account that are known to the transport server at that stage. After such a negative finding the system requires a payment to be effected at step 909, before ending at step 910.

A positive finding at step 908 occurs for example in cases where the passenger pays an estimated fare already at the time of ordering, entering, or leaving the shared transport vehicle and where only corrective calculations are performed afterwards. In such a case the transport server checks at step 911, whether the newly obtained fare from step 907 was the same that the passenger already paid. If not, the system arranges a compensation (typically a crediting order to the passenger's user account) at step 912. If the sums were the same at step 911 or after compensation has been effected at step 912 the procedure ends at step 910. In order to avoid transactions of minimal value compared to the effort it is sometimes advisable to set a certain predetermined limit to the “sameness” of two sums at step 911, so that a transition to step 912 only occurs if the difference is larger than said limit.

Those steps of FIGS. 8a, 8b and 9 that only involve applying the selected formula, which in this case was formula (2), are easily and straightforwardly changed so that the method comes to use another formula.

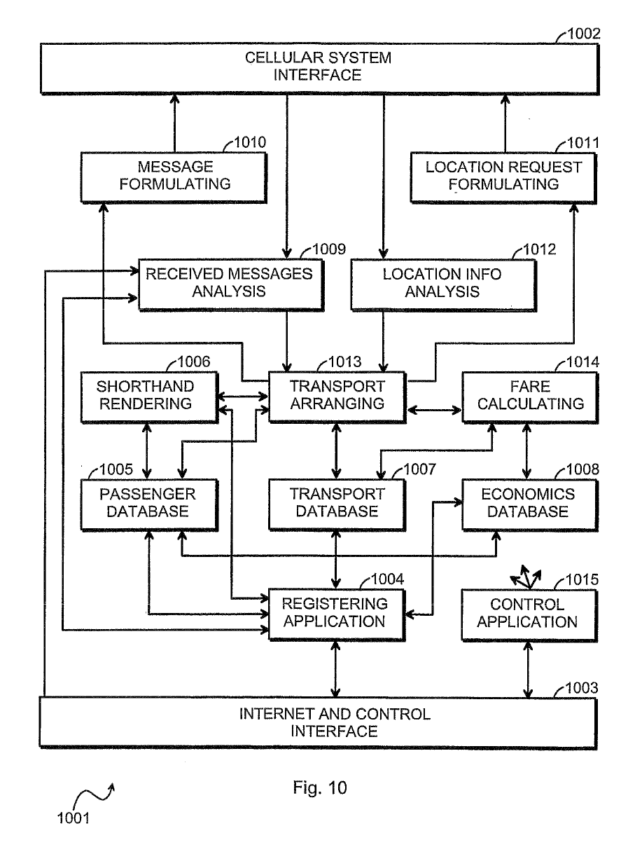

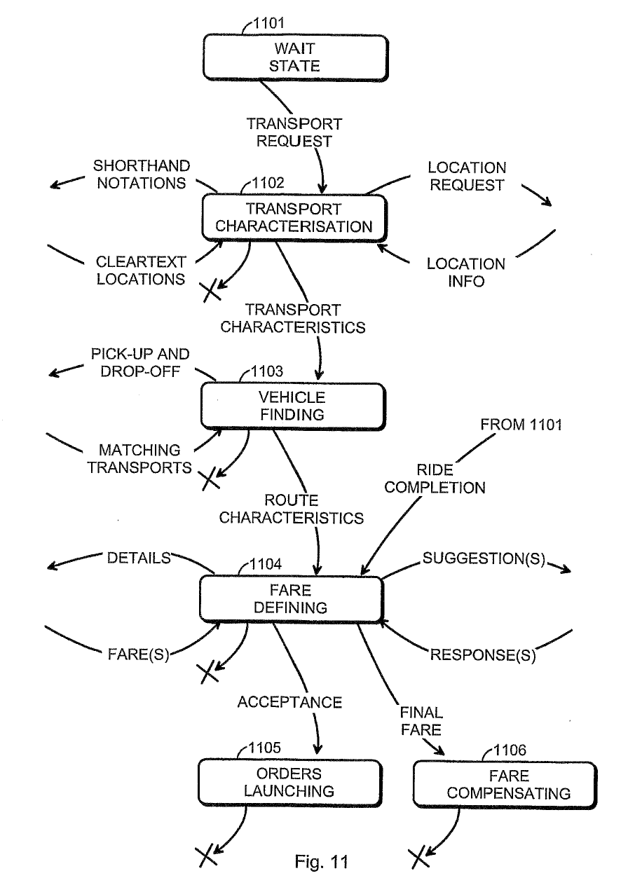

FIG. 10 is a schematic representation of a transport server according to an embodiment of the invention. For communicating with users the transport server 1001 has a cellular system interface 1002 and an Internet and control interface 1003. For handling passenger registrations or subscriptions to the demand responsive transport system there is a registering application 1004, which offers the necessary forms to the passenger through a browser connection and stores the obtained information into the applicable ones of a passenger database 1005, shorthand rendering unit 1006, transport database 1007 and an economic information database 1008. Of these, the passenger database 1005 contains information about the subscribed passengers, such as name, contact information, usage history, passenger-specific authentication information, cryptographic keys, and the like. The shorthand rendering unit 1006 is adapted to interpret shorthand notations into actual location information. The transport database 1007 contains information about possible pick-up and drop-off locations, information about available transport vehicles and information about routes and rides that have already been agreed upon. The economic information database 1008 contains information that is needed to calculate fares, such as parameter values and the rules the determine the correct selection of parameter values. If user accounts are used within the transport server to effect payments and/or compensations, these can belong to either the economic information database 1008 or to the passenger database 1005.

Entities that are adapted for communicating through a cellular radio system include a received messages analysing unit 1009, an outgoing messages formulating unit 1010, a location request formulating unit 1011 and a location information analysis unit 1012. There are all at the disposal of a transport arranging unit 1013, which is the central processing entity at the transport server 1001. The received messages analysing unit 1009 has also connections to and from the Internet and control interface 1003 as well as the registering application 1004 in order to enable passengers to send transport requests also through the internet on one hand and to register through the cellular radio network on the other hand. A fare calculating entity 1014 is shown separately in FIG. 10, although it could also be an integral part of the transport arranging unit 1013.

Transport requests from passengers come through the cellular system interface 1002 and the received messages analysing unit 1009 to the transport arranging unit 1013. If they contain shorthand notations, these are translated into regular location identifiers in the shorthand rendering unit 1006. The transport arranging unit 1013 initiates requesting the location of the passenger through the location request formulating unit 1011 and receives the requested location information through the location information analysis unit 1012. The transport arranging unit 1013 consults the information in the transport database 1007 in order to find the best way of delivering the requested transport. Once a transport alternative has been found, the transport arranging unit 1013 invokes the fare calculating unit 1014 that in turn uses information found in the transport database 1007 and the economic information database 1008 to calculate a fare. Possible exchange of messages with the passenger, regarding alternative routes and positive or negative acknowledgements, is again on the responsibility of the transport arranging unit 1013. If retrospective recalculation of fares is in use, the responsibility of invoking also belongs to the transport arranging unit 1013, even if the fare calculating unit 1014 is the one to perform the actual calculations.

FIG. 10 also illustrates a control application 1015, from which there are connections to all other parts of the transport server 1001 (these are not shown for the reasons of graphical clarity). The purpose of the control application 1015 is to allow a representative of the transport operator to monitor and control the functions of the transport server.

FIG. 11 is a state machine illustration of the operation of an exemplary embodiment of the transport arranging unit 1013 in FIG. 10. The transport arranging unit also constitutes the functional core of a computer program product according to the invention, so the state machine of FIG. 11 can also be regarded as an exemplary graphical representation of certain features of such a computer program product.

When nothing is currently happening, the transport arranging unit is in a wait state 1101. Receiving a transport request causes a transition to a transport characterisation state 1102, the purpose of which is to obtain all knowledge in processable form that is needed for responding to the transport request. The transport characterisation state 1102 comprises obtaining cleartext translations for possible shorthand notations, and obtaining current location information of the passenger. The processes that produce the cleartext translations and the location information are not part of the transport arranging unit proper, so they are not illustrated in FIG. 11.

Having obtained all necessary characteristics of the requested transport causes a further transition to a vehicle finding state 1103. There the transport arranging unit aims at finding at least one transport alternative that would match the needs of the requesting passenger. Revealing the requested pick-up and drop-off points to a transport matching routine in a transport database should produce a list of matching transports. Having found the route and known participant characteristics of all available transport alternatives causes a transition to a fare defining state 1104, in which the transport arranging unit exchanges route and passenger details with calculated fares. Possibly the transport arranging unit also sends suggestions to the requesting passenger and receives responses. When it has been established that one of the alternatives is acceptable, a final transition occurs to an orders launching state 1105. During state 1105 the transport arranging unit ensures that every relevant party receives information about the ride that was agreed upon.

The state machine diagram of FIG. 11 also accounts for the possibility of retrospective recalculation of the fare. An indication in the wait state 1101 about a ride having been completed causes a transition to state 1104, where this time the final, actual fare is calculated, after which there occurs a transition to a compensation effecting state 1106. From all states 1102 to 1106 there is a possible exit back to the wait state, designated as a transition to a cross. Such an exit is used to recover from the occurrence of exceptional incidents, such as not receiving some input that was needed to continue operation in the regular way.

The verb “to comprise” is used in this patent application as an open limitation that does not exclude the existence of also unrecited features. The features recited in depending claims are mutually freely combinable unless otherwise explicitly stated.

The exemplary embodiments of the invention presented in this patent application are not to be interpreted to pose limitations to the applicability of the appended claims. In the following we discuss certain possible modifications of the embodiments of the invention described so far.

Firstly, even if the description above has constantly assumed that the passenger has a mobile terminal at his disposal, it is possible to present at least certain more limited embodiments of the invention where a mobile terminal is not necessary. At least the fare calculation aspects of the invention are applicable to all kinds of shared transport systems, irrespective of whether they were ordered using mobile terminals or not. For example a transport order message might come from a fixed, network-connected computer as well as from a mobile terminal—we must only assume that it then contained at least an approximate indication of a desired pick-up location, which the transport server may accept as such or which the transport server may convert into an exact stopping point selected for pick-up and identified to the passenger in a response message. It must be noted, however, that mobile terminals make it much easier to include the location determination aspects of the invention. Additionally mobile terminals can be easily and reliably used for collecting information concerning who actually took which transport for how long distance.

Secondly, applying the invention does not necessarily require pre-registering according to steps 201 and 202 in FIG. 2. If the (first) transport order message contains all information required to set up a user account, and/or if the transport operator has such confidence in the reliability of passengers that makes it unnecessary to maintain specific user accounts, it is possible to operate solely on the basis of transport order messages.

Thirdly, the time aspects of arranging the transport may also be associated with a desired drop-off time at the desired endpoint instead of any desired pick-up time. In a vast majority of cases the need for a transport is a direct consequence of only the need for being somewhere at a certain predefined moment of time—during the time before entering a transport vehicle the passenger would like to have the freedom to impulsively do what he wants, e.g. to freely wander about the city center, without committing himself to being first at some predetermined transport pick-up location in order to get to the actually desired location. The present invention enables for example the following chain of events:
passenger X sends well in advance a transport order, in which he announces his desire to be at a certain drop-off point (say, the OPERA) at a certain time (say, 18.45)
the transport server registers the transport order but notes that it is of the “well in advance” type, i.e. the desired drop-off time is so far in the future that it does not require arranging a transport yet
during the day the transport server maintains, on the basis of other received transport orders, a list of transports that will be arranged and that will predictably stop (or can reasonably be made to stop) at said desired drop-off point (OPERA) not later than said desired drop-off time (18.45)
at a time that corresponds to taking the longest reasonably possible route within the coverage area of the shared transport system and still being at OPERA in time, the transport server requests and receives the current location of passenger
on the basis of said received location, the transport server proceeds to determine a suggested transport according to what has been described earlier, e.g. in association with FIGS. 4a and 4b.

1. A method for producing and maintaining a record describing how a passenger uses a transport system in relation to how other passengers use the transport system, characterised in that it comprises the steps of:
receiving (203, 401) from a terminal device (101) of a passenger an identifier of a requested drop-off point,
determining (204, 205, 403, 407) an identifier of a requested pick-up point from which said passenger wants to be transported to said drop-off point,
determining (405, 413, 803) a list of stopping point identifiers, which list includes the identifiers of said requested pick-up and drop-off points and constitutes an itinerary for a transport vehicle,
determining (804) a list of passengers that have requested transport between stopping points the identifiers of which appear on said list of stopping point identifiers, and
for each passenger on said list of passengers, determining (801, 804, 901, 904) which passenger-specific group of legs between stopping points belong to the transport requested by that passenger and calculating (802, 805, 806, 807, 808, 902, 904, 905, 906, 907) a record that represents the relation between the passenger-specific group of legs and those other groups of legs that are specific to other passengers on said list of passengers.

2. A method according to claim 1, characterised in that the step of calculating
(802, 805, 806, 807, 808, 902, 904, 905, 906, 907) a record involves calculating a relation between a passenger-specific group of legs and those other groups of legs that are specific to other passengers on said list of passengers, and also us-ing information about occupancy of passengers on each leg, and dimensions of legs between stopping points.

3. A method according to claim 2, characterised in that the step of calculating (802, 805, 806, 807, 808, 902, 904, 905, 906, 907) a record involves calculating a Pi value according to the formula
$${P}_{i} = {\sum }_{l} ( \frac{{O}_{il}}{{\sum }_{j} {O}_{jl}} {D}_{l} )$$
where Pi is a record that represents the relation between the passenger-specific group of legs and those other groups of legs that are specific to other passengers on said list of passengers, Oil is one if an l:th leg belongs to the transport re-quested by an i:th passenger an zero otherwise, Ojl is one if an l:th leg belongs to the transport requested by a j:th passenger an zero otherwise, the summing over index j means summing over all passengers on said list of passengers, Dl is a dimension of an l:th leg between stopping points and the summing over index l means summing over all legs of the itinerary.

4. A method according to claim 1, characterised in that the step of calculating (802, 805, 806, 807, 808, 902, 904, 905, 906, 907) a record involves calculating a relation between the lengths of a passenger-specific direct route and a group of direct routes specific to other passengers, where direct route means a shortest route between requested pick-up and drop-off points, and also using dimensions of legs between stopping points.

5. A method according to claim 4, characterised in that the step of calculating (802, 805, 806, 807, 808, 902, 904, 905, 906, 907) a record involves calculating a Pi value according to the formula
$${P}_{i} = \frac{{d}_{i}}{{\sum }_{j} {d}_{j}} {\sum }_{l} {D}_{l}$$
where Pi is a record that represents the relation between the passenger-specific group of legs and those other groups of legs that are specific to other passengers on said list of passengers, di is a dimension of a direct route between the re-quested pick-up and drop-off points of an i:th passenger, dj is a dimension of a direct route between the requested pick-up and drop-off points of a j:th passenger, the summing over index j means summing over all passengers on said list of passengers, Dl is a dimension of an l:th leg between stopping points and the summing over index l means summing over all legs of the itinerary.

6. A method according to claim 3, characterised in that the step of calculating (802, 805, 806, 807, 808, 902, 904, 905, 906, 907) a record involves additionally scaling a calculated Pi value with a factor
$${d}_{i} / {\sum }_{l} {O}_{il} {D}_{l} ,$$
where di is a dimension of a direct route between the requested pick-up and drop-off points of an i:th passenger, Oil is one if an l:th leg belongs to the transport requested by an i:th passenger an zero otherwise, Dl is a dimension of an l:th leg between stopping points and the summing over index l means summing over all legs of the itinerary.

7. A method according to claim 1, characterised in that at least one of the steps of determining (405, 413, 803) a list of stopping point identifiers and deter-mining (804) a list of passengers involves applying a window (704), which limits consideration to only those stopping points that fulfil at least one of the following criteria:
they appear on said itinerary (701) at or between the pick-up (702) and drop-off (703) points requested by that passenger for which a record is currently to be calculated
they appear on said itinerary at most p legs earlier (706) than the pick-up point (702) requested by that passenger for which a record is currently to be calculated, where p is a system parameter
they appear on said itinerary at most f legs later (705) than the drop-off point (703) requested by that passenger for which a record is currently to be calculated, where f is a system parameter.

8. A method according to claim 7, characterised in that the step of determining (804) a list of passengers comprises one of the following:
only taking those passengers onto the list that have a requested pick-up point within the window (704)
only taking those passengers onto the list that have a requested drop-off point within the window (704)
only taking those passengers onto the list that have a requested pick-up point or a requested drop-off point within the window (704)
only taking those passengers onto the list that have a requested pick-up point and a requested drop-off point within the window (704).

9. A method according to claim 1, characterised in that in respect of a certain passenger it comprises:
first calculating (808) a preliminary record that represents the relation between the passenger-specific group of legs and those other groups of legs that are specific to such other passengers that were known to be on said list of passengers at the time (801) of receiving an identifier of a requested drop-off point from the terminal device of said certain passenger and
later calculating (907) a confirmed record that represents the relation between the passenger-specific group of legs and those other groups of legs that are specific to such other passengers that were known to be on said list of passengers at a time (901) when it is certain that no additional other passengers will appear that should be taken into account.

10. A method according to claim 9, characterised in that it comprises the steps of:
after having calculated (808) a preliminary record, producing (810, 821) a preliminary indication of a fare to be charged from said certain passenger and
after having calculated (907) a confirmed record, producing (909, 912) a con-firmed indication of a fare to be charged from said certain passenger.

11. A method according to claim 10, characterised in that it comprises the steps of:
calculating (911) a difference of said confirmed indication and said preliminary indication and
if said difference is larger than a certain limit, compensating (912) the difference by crediting a user account of said certain passenger.

12. A method according to claim 1, characterised in that the step of determining (204, 205, 403, 407) an identifier of a requested pick-up point involves reading (402) an indicator of the requested pick-up point from a received transport request message that also comprises an indicator of the requested drop-off point.

13. A method according to claim 12, characterised in that it further comprises the steps of:
as a response to receiving a transport request message, requesting and obtaining (403) a location indicator that reveals a current location of a passenger's terminal device,
comparing (404) said location indicator to the indicator of the requested pick-up point, and
only if said comparison (404) shows that the current location of the passenger's terminal device is the same as the requested pick-up point, proceeding to the step of determining (405) a list of stopping point identifiers.

14. A method according to claim 13, characterised in that if said comparison (404) shows that the current location of the passenger's terminal device is not the same as the requested pick-up point, executing the method continues by the steps of:
a) after a certain period of time, requesting and obtaining (403) a new location indicator that reveals a new location of the passenger's terminal device, and
b) comparing (404) said location indicator to the indicator of the requested pick-up point, and
c) repeating steps a) and b) until either said comparison (404) shows that the cur-rent location of the passenger's terminal device is the same as the requested pick-up point, in which case executing the method proceeds to the step of determining (405) a list of stopping point identifiers, or a predetermined other ending condition is fulfilled (409), in which latter case the execution of the method is aborted (410).

15. A method according to claim 12, characterised in that it further comprises the steps of:
as a response to receiving a transport request message, requesting and obtaining (403) a location indicator that reveals a current location of a passenger's terminal device,
comparing (404) said location indicator to the indicator of the requested pick-up point,
proceeding to the step of determining (405, 413) a list of stopping point identifiers,
if said comparison (404) shows that the current location of the passenger's terminal device is not the same as the requested pick-up point, additionally executing the steps of:
estimating (412) a time at which the passenger's terminal device will be at the requested pick-up point through using a calculated difference between the current location of the passenger's terminal device and the requested pick-up point, and
announcing (413) the estimated time to a transport vehicle that is to pick up the passenger at the requested pick-up point.

16. A method according to claim 1, characterised in that the step of determining (204, 205, 403, 407) an identifier of a requested pick-up point involves requesting and obtaining (407) a location indicator that reveals a current location of a passenger's terminal device.

17. A method according to claim 16, characterised in that the method further comprises the steps of:
selecting (408) a pick-up point to be a location that in a database of possible locations is closest to the revealed current location of the passenger's terminal de-vice and
communicating (405, 406) an indicator of the selected pick-up point to the passenger's terminal device and to a transport vehicle that is to pick up the passenger at the selected pick-up point.

18. A method according to claim 1, characterised in that:
the method comprises also a step of determining a requested pick-up time at which said passenger wants to be picked up at said pick-up point,
in case said requested pick-up time is farther ahead in time than a certain limiting time, the method comprises a step of delaying any requesting and obtaining (403) a location indicator that reveals a current location of a passenger's terminal device, until the requested pick-up time is closer than said limiting time.

19. A method according to claim 1, characterised in that:
the step of receiving (203, 401) from a terminal device (101) of a passenger an identifier of a requested drop-off point also involves receiving an identifier of a re-quested drop-off time, and
in case said requested drop-off time is, at the time of receiving said identifiers, farther ahead in time than a certain limiting time, the method comprises a step of delaying the determination (204, 205, 403, 407) of an identifier of a requested pick-up point until the requested drop-off time is closer than said limiting time.

20. A method according to claim 19, characterised in that said limiting time is an estimated longest possible time of travelling from any point within a coverage area of the transport system to said requested drop-off point.

21. A method for determining a fare to be paid by a passenger for the use of a transport system that is also used by other passengers, comprising the steps of:
receiving from a terminal device of a passenger an identifier of a requested drop-off point,
determining an identifier of a requested pick-up point from which said passenger wants to be transported to said drop-off point,
determining a list of stopping point identifiers, which list includes the identifiers of said requested pick-up and drop-off points and constitutes an itinerary for a trans-port vehicle,
determining a list of passengers that have requested transport between stopping points the identifiers of which appear on said list of stopping point identifiers,
for each passenger on said list of passengers, determining which passenger-specific group of legs between stopping points belong to the transport requested by that passenger and calculating a record that represents the relation between the passenger-specific group of legs and those other groups of legs that are specific to other passengers on said list of passengers and
determining a fare to be paid by a passenger by multiplying said record with a constant and adding thereto a flat rate independent of transport distance.

22. A method according to claim 21, characterised in that said steps of deter-mining a fare to be paid are applied to certain passengers that do not have a fixed-term subscription to the use of said transport system.

23. An arrangement (1001) for producing and maintaining records that describe how passengers use a transport system in relation to other passengers, characterised in that it comprises:
reception means (1002, 1009) adapted to receive identifiers of requested drop-off points from terminal devices of passengers,
pick-up point determining means (1011, 1012, 1013) adapted to determine an identifier of a requested pick-up point from which a passenger that has requested a drop-off point wants to be transported to said drop-off point,
stopping point list determining means (1007, 1013) adapted to determine a list of stopping point identifiers, which list includes the identifiers of requested pick-up and drop-off points and constitutes an itinerary for a transport vehicle,
passenger list determining means (1005, 1007, 1013) adapted to determine a list of passengers that have requested transport between stopping points the identifiers of which appear on a determined stopping point list, and
means (1013, 1014) for determining, for each passenger on a certain list of passengers, which passenger-specific group of legs between stopping points belong to the transport requested by each passenger and calculating a record that represents the relation between the passenger-specific group of legs and those other groups of legs that are specific to other passengers on said list of passengers.

24. A computer program product for producing and maintaining records that de-scribe how passengers use a transport system in relation to other passengers, characterised in that it comprises:
computer code means (1102) adapted to receive and handle identifiers of re-quested drop-off points from terminal devices of passengers,
computer code means (1102) adapted to determine an identifier of a requested pick-up point from which a passenger that has requested a drop-off point wants to be transported to said drop-off point,
computer code means (1103) adapted to determine a list of stopping point identifiers, which list includes the identifiers of requested pick-up and drop-off points and constitutes an itinerary for a transport vehicle,
computer code means (1103, 1104) adapted to determine a list of passengers that have requested transport between stopping points the identifiers of which appear on a determined stopping point list, and
computer code means (1104) for determining, for each passenger on a certain list of passengers, which passenger-specific group of legs between stopping points belong to the transport requested by each passenger and calculating a re-cord that represents the relation between the passenger-specific group of legs and those other groups of legs that are specific to other passengers on said list of passengers.
